(19) United States
(12) Patent Application Publication
(10) Pub. No.: US 2012/0312386 A1
(43) Pub. Date: Dec. 13, 2012

(54) Modular pre-fabricated island for vehicular refueling

(75) Inventor: R. Keith Barker, Wahalla, SC (US)

(73) Assignee: HOLYSTONE USA, LLC

(21) Appl. No.: 13/506,898

(22) Filed: May 23, 2012

Related U.S. Application Data
(60) Provisional application No. 61/520,445, filed on Jun. 10, 2011.

(51) Int. Cl. B60S 5/02

(52) U.S. Cl. 137/15.01; 137/363

(57) ABSTRACT

A modular pre-cast concrete station (for gasoline, natural gas and/or other fuels) uses culverts that are assembled quickly and conveniently at the building site and, if desired, in the future, disassembled just as quickly and conveniently, thereby saving substantial costs, and thereby providing an entirely new (and potentially huge) market for the culverts.

### CROSS REFERENCE TO RELATED APPLICATION

Priority of the present application is herewith being claimed as of provisional application Ser. No. 61/520,445 filed on Jun. 10, 2011, the disclosure and contents of which are herein incorporated in their entirety.

### FIELD OF THE INVENTION

The present invention relates to stations for refueling vehicles with gasoline, ethanol, compressed natural gas (CNG) or other hydrocarbon fuels; and more particularly, to a modular design station capable of being erected (and disassembled) very quickly and efficiently and at considerably less cost, yet meets all governmental regulations and specifications (both federal and/or state).

### BACKGROUND OF THE INVENTION

Traditional gasoline stations have fuel islands which are relatively expensive to build and generally take at least a month to complete. These gas stations have storage tanks which are typically buried deep underground. These buried tanks (and their connections) often corrode and leak over time, thereby creating sub-surface contamination. De-contaminating these stations to meet the relatively-rigid governmental environmental standards, is time-consuming and expensive.

Moreover, if the owner wants to convert to non-traditional fuels (especially, CNG) it is expensive to excavate and replace the underground tanks.

Some alternative fuels—as for example, compressed natural gas (CNG)—are better served by storage in above-ground or “atmospheric” tanks. On the other hand, these atmospheric tanks require considerable surface area, not only for the tanks, but also to accommodate setback requirements designed primarily to avoid the threat of motor vehicle impact collisions, as well as the avoidance of electrical wires. As a result, it is difficult and expensive for many existing gas stations to convert to alternative fuels, such as CNG.

Accordingly, it is the primary object of the present invention to obviate the disadvantages and deficiencies of the prior art by providing a modular design fuel station that comprises pre-cast concrete sections—namely culverts—that may be manufactured to relatively-close tolerances and then trucked to the job site and readily assembled.

These pre-fabricated modular concrete culverts are traditionally used for supporting roadbeds while accommodating streams and surface water to safely flow below the roadbeds. The present invention constitutes an entirely new use for those pre-cast concrete culverts.

With the present invention, a gasoline (or other fuel) station may be assembled on site in around a week or so, and at substantially less cost. A conventional gas station requires around a month.

In accordance with the disclosure and teachings of the present invention, there is herein disclosed and illustrated, a modular pre-fabricated fuel station that is assembled at a given site. A plurality of pre-cast U-shaped culverts are nested end-to-end with respect to each other and are assembled at the site; and a top slab encloses the plurality of culverts, thereby forming a load-bearing vault which is capable of accommodating normal vehicular traffic. At least one fuel tank is within the vault, and at least one above-ground pump is connected to the tank (in a conventional manner).

In a preferred embodiment, the vault is primarily below ground and extends partially above-ground; and ingress and egress (entrance and exit ramps), respectively, are provided on either side of the pump.

Additionally, respective modular end caps are provided for the plurality of culverts, thereby completing the vault.

Preferably, the vault—and the fuel tank primarily housed therein—are both substantially rectangular.

The culverts have cooperating respective male and female surfaces, thereby forming joints therebetween, and a sealing means is applied to the respective joints.

The present invention also accommodates the dispensing of compressed natural gas (CNG) which is normally stored in an above-ground or “atmospheric” tank. As previously noted, these atmospheric tanks normally require considerable surface area and setback requirements designed primarily to avoid the possible threat of vehicular impact collisions. In this invention, the vault is in a relatively shallow excavation, and a CNG tank may be disposed within the vault.

In a preferred embodiment, a canopy is supported by at least one hollow column. The lower portion of the column is in communication with the vault, thereby providing a desired ventilation of the vault in the event the tank is ruptured, and thereby substantially mitigating the risk of an explosion.

Viewed in another aspect, the present invention provides a method of constructing a modular fuel station at a given site, such as in a shopping mall or array of “big box” stores. The method includes the step of pre-casting concrete culverts at a manufacturing facility having built-in quality-control production procedures. The culverts are delivered to a given site by means of a truck or trailer having a hoist, thereby avoiding the necessity of employing a giant crane that might otherwise interfere with existing structures or overhead power lines. A relatively shallow pit is excavated for a plurality of culverts. These culverts nest with each other; and a sealing means is provided at the interfaces therebetween, thereby forming a vault which is primarily below ground and partially above ground. A fuel tank is lowered within the vault and is connected to a pump on a top cover of the vault. Respective ingress and egress ramps are provided on either side to accommodate a vehicle being re-fueled; these ramps compensate for the partial above-ground extension of the vault and the top thereof.

These and other objects of the present invention will become apparent from a reading of the following specification, taken in conjunction with the enclosed drawings.

### BRIEF DESCRIPTION OF THE DRAWINGS

FIG. 1 is a longitudinal section of the completed modular fuel station of the present invention, showing the assembled culverts forming the vault. [In this example, the culverts forming the vault are disposed parallel to the direction of vehicular traffic to (and from) the pump; however, and depending upon the particular site, the vault could be perpendicular with respect to the direction of vehicular traffic.]

FIG. 2 is a cross-sectional view thereof, taken along the lines 2-2 of FIG. 1, showing the array of assembled culverts and the respective end caps constituting the completed vault, the vault being partially cut away to show the rectangular tank within the vault.

FIG. 3 is a transverse cross-section, taken along the lines 3-3 of FIG. 2, and further illustrates the rectangular tank in the vault.

FIG. 4 is an exploded perspective view of (a portion of) the nested culverts forming the vault of the present invention.

FIG. 5 is a further perspective view, corresponding substantially to that of FIG. 4, but showing (a portion of) the array of culverts in an assembled, nested relationship.

FIG. 6 is a sectional view, drawn to an enlarged scale, and showing one of the inter-fitting over-lapped joints between the end-to-end culverts and the sealant therebetween.

FIG. 7 is a partial elevational view of the assembled modular station, drawn to an enlarged scale, and showing the lower end of the canopy in communication with the vault, thereby venting any hydrocarbon vapors in the vault.

FIGS. 8-11 are schematic pictorial views, generally illustrating the on-site assembly and installation of the modular-design fuel station of the present invention.

More specifically, FIG. 8 illustrates the excavation of a relatively-shallow pit for the assembled culverts to basically form the vault therein.

FIG. 9 illustrates the unloading of the culverts from a medium-sized truck with a built-in hoist, and further illustrating the initial assembly of the culverts within the pit (and, thereafter, the end caps and top slab to form the vault for the tank).

FIG. 10 illustrates the rectangular tank being lowered into the vault, and the respective ramps being installed.

FIG. 11 illustrates, schematically, the installation of the pump and canopy to complete the fuel station. [The mechanical and electrical connections, being conventional, have been omitted for ease of illustration.]

FIG. 12 is a schematic block diagram of the method steps of FIGS. 8-11, respectively.

### GENERAL DESCRIPTION OF THE PREFERRED EMBODIMENTS

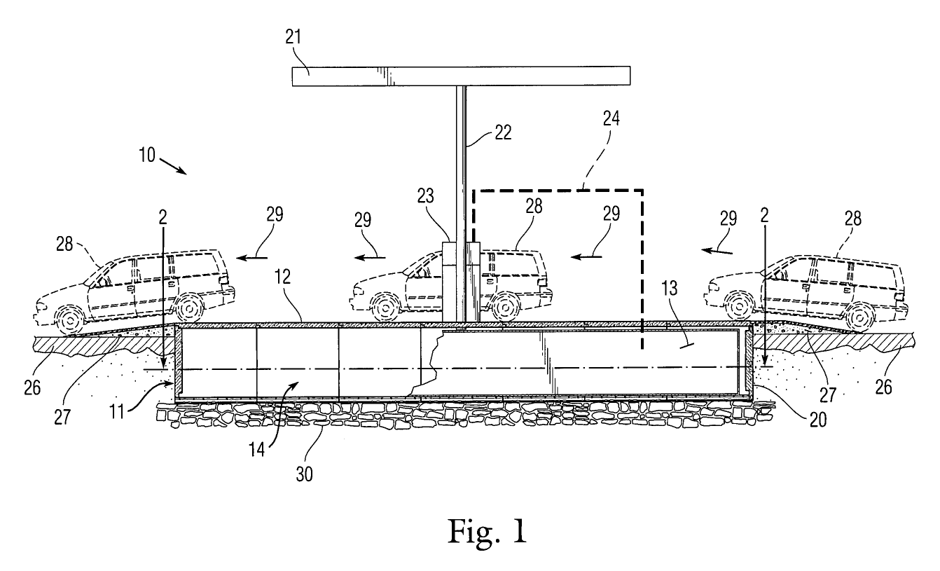

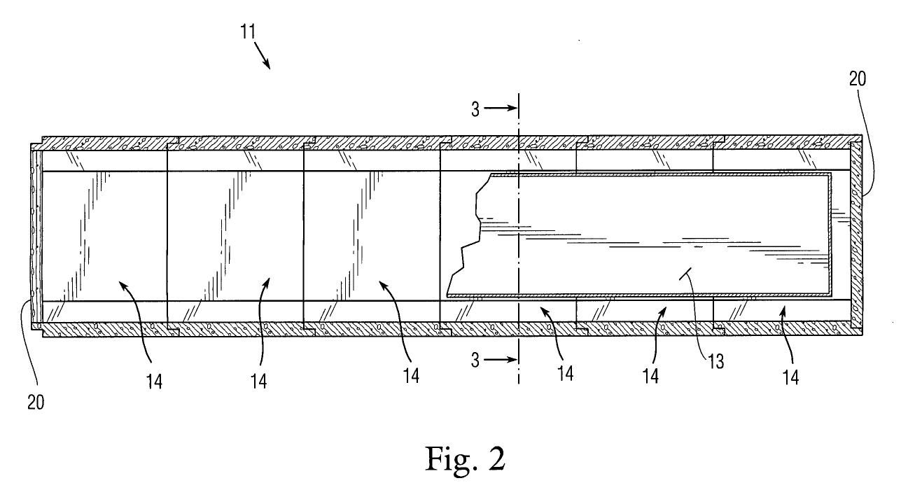

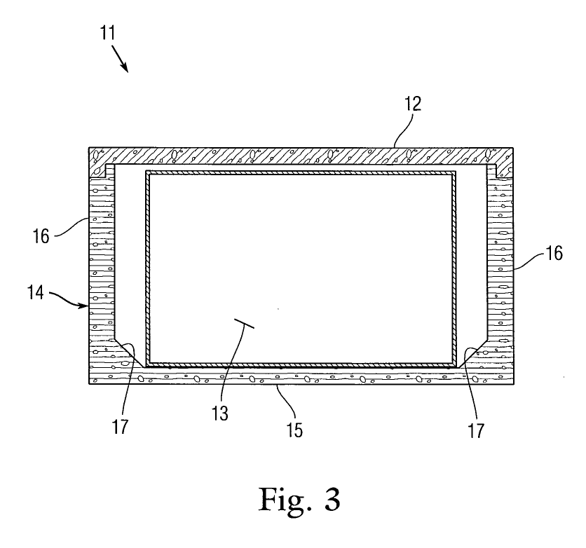

With reference to FIGS. 1 and 2, the modular fuel station 10 of the present invention includes a vault 11 having a top slab 12. The vault 11 is substantially below ground, but partially above ground. Preferably, the vault 11 is rectangular and houses therein a complementary rectangular tank 13 (see FIG. 3). However for compressed natural gas the tank 13 would be cylindrical to meet pressure requirements.

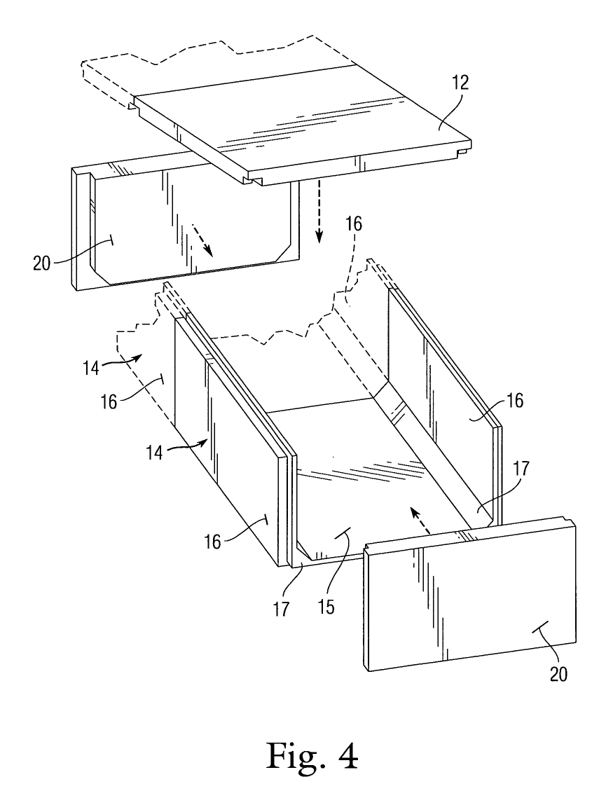

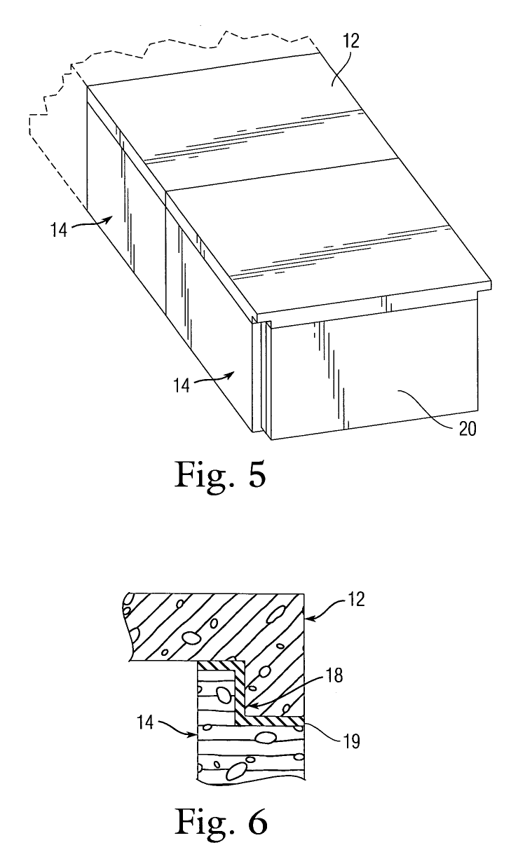

With reference to FIGS. 3 and 4, the vault 11 is constructed from pre-fabricated concrete culverts 14. The culverts 14 are substantially U-shaped with a base 15, respective legs 16, and reinforcing gusset plates 17 between the base 15 and the respective legs 16]. These culverts 14 are normally employed for an altogether different purpose. With reference again to FIGS. 1 and 2 and with further reference to FIGS. 3-6, the culverts 14 overlap and nest end-to-end with respect to each other as at joints 18 (see FIG. 6) and a suitable sealant 19 is disposed in the joints 18.

End caps 20 (see FIGS. 3 and 4) complement the nested culverts 14 and the top 12 to form the completed vault 11. Preferably, the top 20 is formed by nested sections (like the culverts 14).

With reference again to FIGS. 1, and with further reference to FIG. 7, the fuel station 10 includes a canopy 21 supported by a column 22. Preferably, the column 22 is hollow, and the end of the column 22 extends partially into the vault 11. Accordingly, any hydrocarbon vapors or fumes within the vault 11 may be vented to the atmosphere. [These vapors may be monitored, if desired.]

As will be readily understood and appreciated by those skilled in the art, the mechanical and electrical connections to the pump 23, being conventional, have been omitted for ease of illustration and are represented, schematically, by the “heavy” broken line 24 (see FIG. 1).

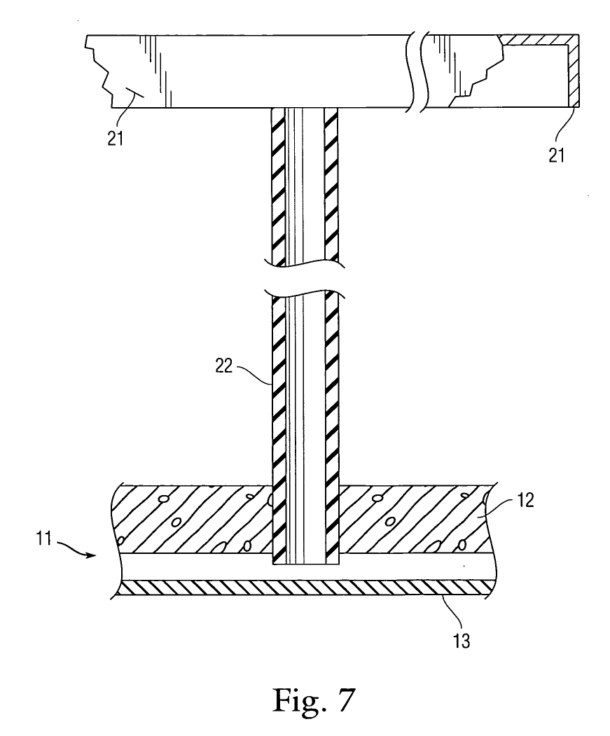

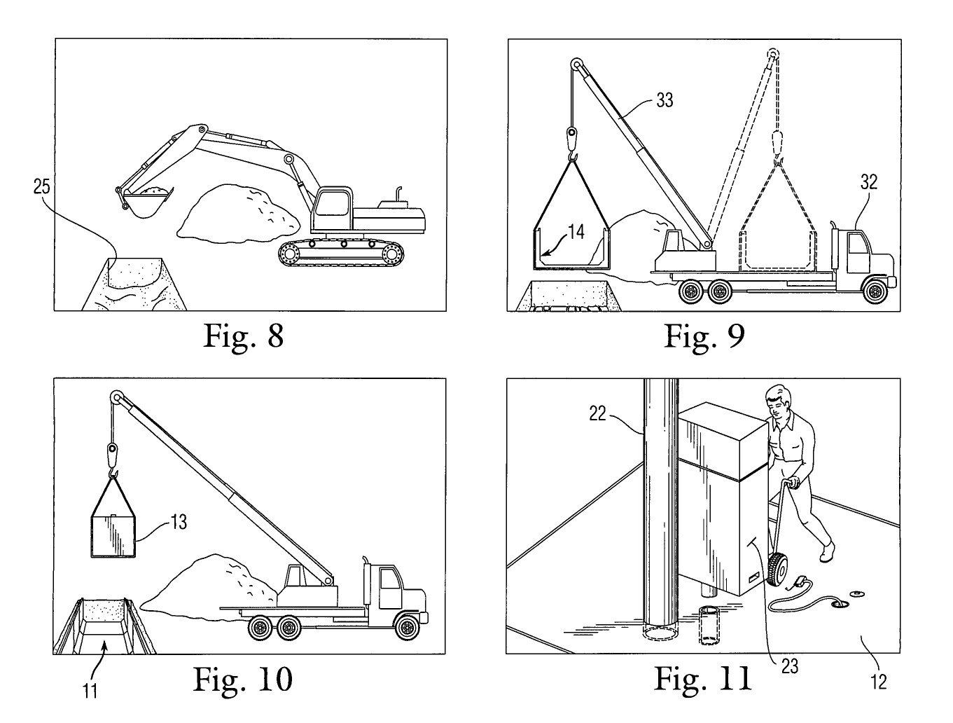

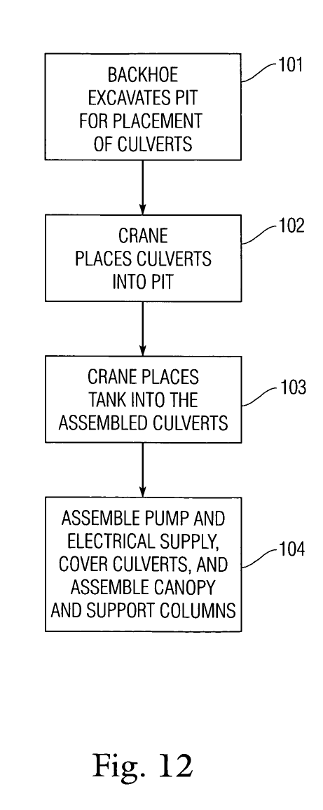

With reference to FIG. 8, in step 101 a pit 25 is dug for the vault 11 and in step 102, the vault 11 is constructed from the culverts 14 (FIG. 9). The tank 13, preferably, is rectangular and nests relatively closely within the vault 11 in step 103 (see FIG. 3). Finally, in step 104, the pump 23 and electrical supply are connected; the culverts 14 are covered, and the canopy 21 and column 22 are assembled.

All of the concrete parts are modular and are delivered to the job site by a truck 32 equipped with a hoist; preferably the hoist is telescoping.

To compensate for the vault 11 being partially above the ground surface 26, a pair of complementary ramps 27 is provided for the convenient ingress and exit, respectively, of the vehicular traffic. An example is a typical SUV 28 (illustrated by the broken lines) and the direction of traffic is indicated by the arrows 29 (see FIG. 1).

Typical Example of a Completed Modular Station

In the present invention, the site is excavated to a depth of approximately four-and a half feet, a width of ten feet, and a length of ninety-two feet to form the pit 25. A six inch layer of stones 30 is laid on the bottom of the pit 25 (see FIG. 1) to mitigate sinking and settling. Each culvert 14 is hoisted into place by a small crane or hoist which may be mounted on the back of the truck. [Accordingly, a large crane is not necessary, nor are we concerned with overhead high-voltage wires.] Approximately fifteen culverts 14 and two end caps 20, together with the top slab 12, form the vault 11 for a single-pump island 10.

Each culvert 14 is approximately six feet long, seven feet wide, four feet high, and eight inches thick. Each culvert 14 weighs around three thousand (3,000) pounds, but a relatively small crane can comfortably maneuver up to around ten thousand (10,000) pounds.

The pre-cast concrete U-shaped culverts 14 (monolithic poured base 15 and legs or walls 16 are lap jointed together (male and female on the open ends) to form the joint 18. Additionally, the top of the culverts 14 have a female groove to receive a male tongue 31 on the top slab 12.

The pre-cast U-shaped sections (culverts 14) adjoin quickly and seamlessly to align in a straight line locking construction method. The lap and tongue groove joints 18 are designed to accept a multiple gasket material (sealant 19) to prevent leakage, thereby meeting national regulations as a secondary containment for single-walled fuel storage tanks and to prevent exterior groundwater seepage into the vault 11.

The inside dimension of the vault is four feet high. An eight inch thick concrete monolithic poured floor slab is attached to the four foot high walls. A ten inch thick top slab 12 provides for four inches to become the male tongue top slab joint with six inches exposed above the four foot wall height.

The exterior tank culvert dimension of eight feet wide by ninety feet long and comprises about fifteen culverts 14, each six feet. The excavation is represented to extend one foot beyond these dimensions and ten feet wide by ninety-three feet long. These dimensions account for the culvert tank walls to be six inches thick or seven inches wide by eighty-nine feet long inside the vault.

The constructed four vault walls are comprised of seventeen pieces.

The top of the vault 11, which is also the driving surface, is comprised of fifteen pieces of precast concrete. Each piece is eight feet long, six feet wide, and ten inches thick. Each piece weighs approximately 5,976 pounds. A top slab tongue and groove joint is cast to lock sections together (substantially identical to the joints between the culverts 14).

All precast concrete slabs are tongue and groove or lap jointed with male and female halves so they adjoin quickly and seamlessly. Each precast concrete section is cast with six inch extended male and six inch recessed female lap joint ends. The male lap-joint end is set into a female lap-joint section in succession to build any required length of the culvert.

The interior of the vault can be coated with a petroleum resistant polymer liner (not shown) to meet NFPA secondary containment standards for single wall petroleum storage tanks.

One or more canopy column support brace(s) are mechanically attached to the inside precast concrete culvert wall. The up-lift and down-load stresses are designed into the cross brace system to support the canopy 21. The column 22 is designed with atmospheric venting from the vault 11 to the top of the canopy 21. Since the top slab 12 is set to an elevation above storm water mean run-off, compacted soil is used in the construction of driveway ingress and egress on all four sides, creating a ramp. Ramps are added around the periphery of the top to allow for easy ingress and egress. The column is designed with atmospheric venting from the vault to the top of the canopy.

Inside the vault are three cross braced canopy column u-lift and down-load support anchors (not shown). These support anchors span the width and are the inside length of the vault 11 at the bottom of the joint elevation to allow for top slab placement. The support anchor is fastened to the vault by cast concrete anchors. This feature allows the fuel island to be 100% modular.

The fuel island 10 can also provide a modular attendant kiosk with waste and water storage containers constructed inside the vault for a restroom. A manhole may be provided (not shown) for entry inside the vault 11.

Recessed lifting eyes (not shown) are cast into the sectional pieces thus making the pieces easy to assemble and disassemble by crane. The canopy 21 comprises vertical sections which are bolted together to be modular. Weld-plates can be cast into the base unit and top slabs joints to stabilize the structure in the event of earthquakes and tremors.

Commercial Advantages

The present invention constitutes a new application for pre-cast concrete culverts. These culverts may be pre-cast to relatively close tolerances; and, being sufficiently small and nested, may be trucked to the job site and unloaded by a relatively-small crane on a truck or trailer. If desired, the culverts may be reinforced with rebars.

The modular design will accommodate 8,000 gallon semi-tanker fuel loads. The pre-cast pieces (culverts 14, etc.) may be quickly assembled at the job site (or thereafter disassembled and moved to an alternate location, if desired). A shallow excavation is sufficient, and there is no need to bury the culverts 14 (since the culverts are normally used for bridges) thereby substantially reducing excavation time and related costs. The culverts 14 may be engineered to handle all kinds of weight loads—by adding thickness and/or rebars to the culverts 14—so that, if desired, the culverts can be used as a foundation for a convenience store at the site, while expanding the volume and number of the fuel tanks within the vault.

The modular design fuel station 10 may be manually supervised and operated by an attendant (or attendants) or supervised and operated remotely as illustrated and disclosed, for example, in the Barker U.S. Pat. No. 7,096,895 issued on Aug. 29, 2006. The contents, disclosure and teachings therein are hereby incorporated herein by cross-reference in their entirety.

Multiple individual fuel islands could be constructed on a site and on a per respective fuel basis; and a single pump could service a variety of stored fuels in respective adjacent vaults 11.

The top of the vault 11, preferably, should be above the mean storm water run-off at the particular site.

The modular self-contained fuel islands of the present invention may be constructed in environmentally-sensitive areas.

Obviously, many modifications and/or improvements may be made to the present invention. For example, while only one pump in a single fuel island 10 has been illustrated and disclosed (for ease of illustration purposes) more than one pump or island may be employed consonant with the teachings of the present invention. Additionally, the pre-cast culverts 14 may be reinforced by rebars, as well as employing conventional weld-plates. Accordingly, it will be appreciated by those skilled in the art that with the scope of the approved claims, the present invention may be practiced other than that which has been specifically disclosed herein.

1. A modular prefabricated fuel station assembled at a given site, comprising a plurality of precast U-shaped culverts nested end-to-end with respect to each other and assembled at the site, a top slab enclosing the plurality of culverts, thereby forming a load-bearing vault capable of accumulating normal vehicular traffic, at least one fuel tank within the vault, and at least one above-ground pump connected to the tank.

2. The modular prefabricated fuel station of claim 1, wherein the vault is primarily below ground and extends partially above-ground, and wherein ingress and exit ramps, respectively, are provided on either side of the pump.

3. The modular prefabricated fuel station of claim 1, further including respective modular end caps for the plurality of culverts.

4. The modular prefabricated fuel station of claim 1, wherein the vault and the fuel tank primarily housed therein, are both substantially rectangular.

5. The modular prefabricated fuel station of claim 1, wherein the culverts have cooperating respective male and female end surfaces, thereby forming joints therebetween, and wherein a sealing means is applied to the respective joints.

6. The modular prefabricated fuel station of claim 1, further including a canopy, the canopy including at least one supporting column connected to the vault, and the column being substantially hollow, and extending at least partially into the vault, thereby forming a chimney for releasing escaping vapors into the atmosphere.

7. A modular prefabricated fuel station assembled at a given site, comprising a plurality of precast concrete culverts which are substantially U-shaped with respective bases resting on a foundation, the culverts being nested end-to-end with respect to each other, respective end caps for the plurality of culverts, the culverts and end caps having cooperating male and female and surfaces forming joints therebetween, a sealing means applied at the joints, a top slab enclosing the plurality of culverts and keyed thereto, thereby forming a load-bearing vault capable of accommodating normal vehicular traffic, the vault being primarily below ground and partially above ground, at least one fuel tank within the vault; at least one above-ground pump connected to the tank, respective ingress and exit ramps on either side of the pump, and a canopy above the pump, the canopy having at least one supporting column connected to the vault, and the column being substantially hollow for piping escaping vapors into the atmosphere.

8. The method of erecting the modular prefabricated fuel station of claim 7.

9. A modular prefabricated fuel station assembled at a given site, comprising a plurality of precast culverts nested end-to-end with respect to each other and assembled at the site, thereby forming a load-bearing vault capable of accommodating normal vehicular traffic, a fuel tank housed primarily in the vault and partially above ground, at least one above-ground pump connected to the pump, and respective ingress and exit ramps on either side of the pump.

10. A modular prefabricated fuel station assembled at a given site, comprising a vault primarily underground and partially above ground, a fuel tank within the vault, a pump connected to the tank, respective ingress and exit ramps on opposite sides of the pump, a canopy for the pump, and at least one supporting column for the canopy, the column being connected to the vault and being substantially hollow for exhausting any vapors in the vault to the atmosphere.

11. A modular prefabricated precast-concrete fuel island capable of storing and dispensing various fuels including compressed natural gas (CNG) normally stored in an above-ground or “atmospheric” tank which thereby requires considerable surface area and setback requirements designed primarily to avoid the threat of vehicular impact collisions, comprising a vault in a relatively shallow excavation, at least one fuel tank in the vault, the vault having a top which is above the groundwater mean level, a pump on top of the vault, and respective ingress and egress ramps to the top of the vault, thereby accommodating convenient vehicular access to the pump, and thereby constructing the fuel island in substantially less time and cost.

12. The modular prefabricated precast-concrete fuel island of claim 11, further including a canopy supported by at least one hollow column, the lower portion of the canopy being in communication with the vault, thereby providing a desired ventilation of the vault in the event the tank is ruptured, and thereby substantially mitigating the risk of an explosion.

13. The method of constructing a modular fuel station at a given site, such as a shopping center or an arrangement of “big box” stores, comprising the steps of pre-casting concrete culverts at a manufacturing facility having built-in quality-control production procedures, trucking the culverts to a given site by means of a truck or trailer having a hoist thereon, thereby avoiding the necessity of a giant crane that might otherwise interfere with existing structures or overhead power lines, excavating a relatively shallow pit, connecting the culverts so that the culverts nest with each other, and providing a sealing means at the interfaces therebetween, thereby forming a vault which is primarily below ground and partially above ground, lowering a fuel tank within the vault and connecting the tank to a pump on a top cover for the vault, and building respective ingress and egress ramps on either side to accommodate a vehicle being re-fueled and compensating for the partial above-ground extension of the vault and the top thereof.

14. The method of claim 13, further including the step of providing at least one column for supporting a canopy for the pump, the column being substantially hollow and having a lower portion in communication with the vault, thereby facilitating an exhaust of any vapors in the vault.

15. A modular-design fuel station, such as a gasoline station, comprising pre-cast concrete sections which are manufactured off-site and are conveniently trucked to the site and quickly assembled thereon to form a fuel island, and, if desired in the future, quickly disassembled and removed from the site, a pump on the island, and means providing vehicular access to (and from) the island and the pump thereon.

16. The modular-design fuel station of claim 15, wherein the pre-cast concrete sections comprise culverts which are assembled end-to-end at the site to form a vault for a fuel tank, the vault being partially above ground, and wherein the means providing vehicular access to (and from) the island comprises a ramp means that compensates for the vault being partially above the ground level.

17. In a modular fuel station, the combination of a plurality of substantial U-shaped culverts nested and stacked end-to-end with respect to each other, respective end caps for the culverts, and a top cover for the culverts, thereby forming a substantially sealed vault, and at least one fuel tank within the vault.

18. The combination of claim 17, wherein the vault is partially above the ground level, and wherein respective ingress and egress ramps are provided, thereby substantially compensating for the extent to which the vault is above ground, and thereby providing convenient vehicular access to the pump.
